(19) United States
(12) Patent Application Publication
(10) Pub. No.: US 2024/0303703 A1
(43) Pub. Date: Sep. 12, 2024

(54) SYSTEM FOR CONSTRUCTING DIGITAL CLOSET AND METHOD OF CONSTRUCTING DIGITAL CLOSET

(71) Applicant: LOOKO INC., Daejeon (KR)

(72) Inventor: Hea Sin KO, Daejeon (KR)

(21) Appl. No.: 17/928,661

(22) PCT Filed: Sep. 7, 2021
(86) PCT No.: PCT/KR2021/012107

§ 371 Date: Nov. 30, 2022

(30) Foreign Application Priority Data
Jul. 20, 2021 (KR) 10-2021-0094830

(51) Int. Cl. G06Q 30/0601; G06F 40/205; G06V 30/10

(52) U.S. Cl. CPC G06Q 30/0601; G06F 40/205; G06V 30/10

(57) ABSTRACT

A system for constructing a digital closet is disclosed. The system for constructing a digital closet includes: a user terminal that interlocks email account information or identifier information for digital closet registration to a digital closet service platform, receives core information related to clothing purchased in online or offline, and creates a digital close on the basis of information selected by a user from the received clothing-related core information; and a server that collects the clothing-related core information from a database related to the purchased clothing on the basis of the email account information or the identifier information, and transmits the clothing-related core information to the user terminal. Accordingly, clothing purchased through offline or online is simply registered in a digital closet, thereby being able to maximize convenience for a user.

### FIELD

The present disclosure relates to a system for constructing a digital closet and a method of constructing digital closet, in more detail, a system for constructing a digital closet and a method of constructing digital closet, the system and method easily registering clothes purchased in online or offline into a digital closet.

### BACKGROUND

The demands for personalized services are explosively increasing with the development of big data and artificial intelligence technologies. A personalized service, which provides a service that a user would prefer by analyzing the individual taste and desire of the user, can be applied to almost all fields including food, movie, traveling, and news. A fashion industry is also a field to which personalized services have been considerably applied, and the personalized services are used in the way of recommending products, which are expected to be preferred and very likely to be purchased by users, of recommending relevant shopping malls, or the like.

It is necessary to sufficiently find out the characteristic of each user in order to provide a good personalized service, but it is very difficult to find out individual fashion information in the fashion field. For example, it is substantially impossible for fashion service providers to obtain information about what kinds of clothes individuals have, what clothes individuals frequently wear or not, the body sizes and a sense of fitting of users, etc. Accordingly, most fashion personalized services at most recommend fashion products by estimating the tastes of users on the basis of indirect information of the users such as age, sex, search history, etc.

Information about clothes of users, what coordination the users make with the clothes, what clothes they wore, when they wore the clothes, and what styles they created is core data that are the base of an excellent fashion personalized service. Accordingly, there were many attempts to obtain such user closet data. For example, “smart closet”, “your closet”, etc. that are smartphone applications that were released in 2016 and are being serviced at present provide a function enabling individuals to make their own virtual closets. However, users can construct their own virtual closets by taking pictures of hundreds of clothes in person, remove thing backgrounds in the pictures in person, and inputting various items of information about the clothes. Further, users records when they wore corresponding clothes, how they coordinate, etc. in the calendar of the application in person. However, these services failed to collect many users due to the trouble that users one by one have to take pictures of clothes in person, remove the backgrounds in the pictures, and input various items of information in person. Further, many similar services that enable users to manage closets in the field of online existed, but most users are indifferent to those services because it is very difficult and troublesome to construct a virtual closet.

### SUMMARY

An objective of the present disclosure is to provide a system for constructing a digital closet and a method of constructing digital closet, the system and method easily registering clothing purchased in online or offline into a digital closet.

In order to achieve the objectives, a system for constructing a digital closet according to an embodiment of the present disclosure includes: a user terminal that interlocks email account information or identifier information for digital closet registration to a digital closet service platform, receives core information related to clothing purchased in online or offline, and creates a digital close on the basis of information selected by a user from the received clothing-related core information; and a server that collects the clothing-related core information from a database related to the purchased clothing on the basis of the email account information or the identifier information, and transmits the clothing-related core information to the user terminal.

The server may extract a clothes-related email from emails received in a mail server on the basis of the email account information, extract information about the clothing purchased in online on the basis of the content of the extracted email, and extract the clothing-related core information from a product sale site corresponding to the information about the clothing purchased in online.

The online-purchased clothing-related information may include at least one a sale route and a name of the clothing purchased in online, and information about options of the user when purchasing the clothing in online, and the server performs OCR processing on an image included in the content of the extracted email, and performs text parsing on a text included in the content of the extracted email, thereby extracting the online-purchased clothing-related information.

The server may search for the product sale site on the basis of the sale route of the online-purchased clothing, collect images and texts posted on the product sale site, and extract and transmit the clothing-related core information including an image and a text related to the online-purchased clothing to the user terminal.

The server may receive information about clothing purchase in offline on the basis of the identifier information, search for product data matched to the offline-purchased clothing-related information from a product database, and transmit the offline-purchased clothing-related information and the clothing-related core information including the matched product data to the user terminal.

The offline-purchased clothing-related information may include at least one of the information of a selling area at which the clothing was purchased in offline, specification information about the clothing purchased in offline, and payment information.

The matched product data may include at least one of an image, a name, and a size of the offline-purchased clothing.

When receiving the clothing-related core information, the user terminal may register an image or a text selected by user's operation in a digital closet or may register an image or a text corrected by user's operation in a digital closet.

The user terminal analyzes similarity between the image or the text registered in the digital closet and pre-stored clothing data, combines clothing of which the similarity satisfies a preset reference or more, thereby being able to create a coordinated combination.

A method of constructing a digital closet of a system for constructing a digital closet including a user terminal and a server according to an embodiment of the present disclosure includes: a step in which the user terminal interlocks email account information or identifier information for digital closet registration to a digital closet service platform, and transmits online-purchased clothing-related information or offline-purchased clothing-related information to the server on the basis of the email account information; a step in which the server collects clothing-related core information from a database related to at least one of the clothing purchased in online and the clothing purchased in offline on the basis of the received online-purchased clothing-related information or offline-purchased clothing-related information, and transmits the clothing-related core information to the user terminal; and a step in which the user terminal constructs a digital closet on the basis of information selected by a user from the received clothing-related core information.

According to various embodiments of the present disclosure described above, clothing purchased through offline or online is simply registered in a digital closet, thereby being able to maximize convenience for a user.

### BRIEF DESCRIPTION OF THE DRAWINGS

FIG. 1 is a configuration view of a system for constructing a digital closet according to an embodiment of the present disclosure.

FIG. 2 is a diagram showing detailed data processing of the system for constructing a digital closet according to an embodiment of the present disclosure.

FIG. 3 is a diagram showing detailed data processing of the system for constructing a digital closet according to another embodiment of the present disclosure.

FIG. 4 is a diagram illustrating a method of creating a coordinated combination according to an embodiment of the present disclosure.

FIG. 5 is a flowchart illustrating a method of constructing a digital closet according to an embodiment of the present disclosure.

### DESCRIPTION OF EXEMPLARY EMBODIMENTS

The present disclosure is described hereafter in detail with reference to the accompanying drawings. Further, in describing the present disclosure, detailed descriptions of well-known functions or configurations relating to the present disclosure will not be provided so as not to obscure the description of the present disclosure with unnecessary details. Further, the following terminologies are defined in consideration of the functions in the present disclosure and may be construed in different ways by the intention or practice of users and operators. Therefore, the definitions thereof should be construed based on the contents throughout the specification.

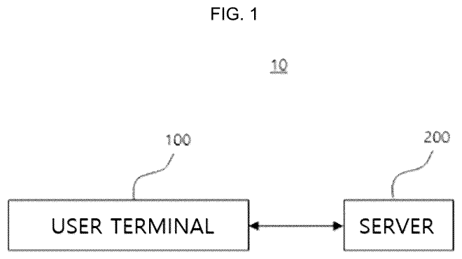

FIG. 1 is a configuration view of a system for constructing a digital closet according to an embodiment of the present disclosure.

Referring to FIG. 1, a system 10 for constructing a digital closet according to an embodiment of the present disclosure includes a user terminal 100 and a sever 200.

In this specification, the system 10 for constructing a digital closet, which is a system for constructing a virtual closet by registering information about clothing purchased by a user, means a system that making information such as images or specifications related to clothing purchased by a user into a database such that when the user opens a digital closet in online, the clothing purchased by the user can be provided to the user through images or texts.

Further, the user terminal 100 may be implemented as a smartphone, a mobile device, etc., but is not limited thereto and may be implemented as various electronic devices such as a PDA, a pad type PC, a tablet PC, a wearable device, etc.

In this configuration, the user terminal 100 may interlock email account information or identifier information for digital closet registration to a digital closet service platform.

In detail, the user terminal 100 can interlock email account information of a user or identification information that is used when a user purchases clothing to an application related to a digital closet service platform, and the interlocked email account information of a user or identification information can be used to register information such as images or specifications of clothing purchased by the user into a digital closet. Further, the user terminal 100 can create a digital closet on the basis of information selected by a user from received clothing-related core information. For example, the user terminal 100 can ask a user to check clothing-related core information through a digital closet platform and the user can sort information for registering images, texts, etc. included in the clothing-related core information into a digital closet or may correct wrong information in person when there is wrong information.

Accordingly, the user terminal 100 can register clothing-related core information selected or corrected by a user.

Meanwhile, the server 200 can collect clothing-related core information from a database related to purchased clothing on the basis of email account information or identifier information for digital closet registration, and can transmit the clothing-related core information to the user terminal 100.

In detail, the server 200 can collect core information related to clothing purchased in online from a database related to clothing purchased in online on the basis of email account information for digital closet registration and can transmit the core information to the user terminal 100, and can collect core information related to clothing purchased in offline on the basis of identifier information and can transmit the core information to the user terminal 100.

That is, the server 200 collects information about clothing purchased through online and clothing purchased through offline on the basis of email account information or identification information, extracts clothing-related core information by refining the information, and then transmits the clothing-related core information to the user terminal 100, and the user terminal 100 registers the received clothing-related core information into a digital closet.

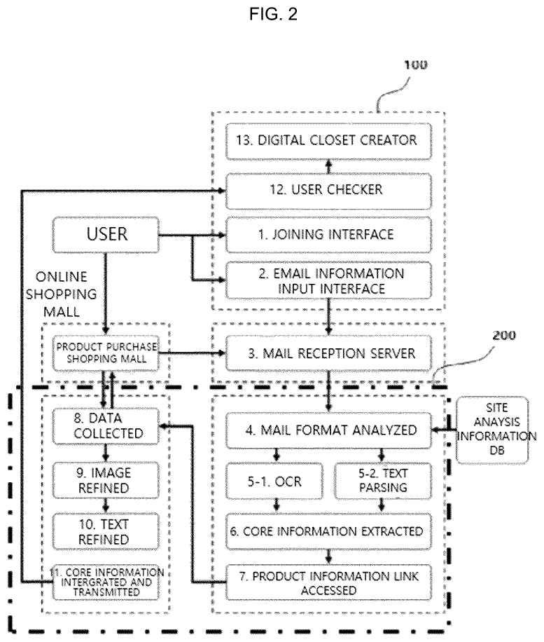

FIG. 2 is a diagram showing detailed data processing of the system for constructing a digital closet according to an embodiment of the present disclosure.

Referring to FIG. 2, a data processing process between the user terminal 100 and the server 200 of the system 10 for constructing a digital closet is shown. In detail, a digital closet service platform that is driven in the user terminal 100 is implemented as an application, a user has to perform joining in order to use this digital closet service platform, and a user interface for supporting such joining can be displayed.

When a user inputs email account information while joining a digital closet service platform through a user interface, the digital closet service platform can acquire login information including an email ID, a password, etc. from the email account information.

Further, the user terminal 100 transmits the email account information, that is, the email ID, the password, etc. to the server 200, and the server 200 can analyze the mail format on the basis of the email account information.

In detail, the server 200 can extract clothing-related emails from emails received in a mail server on the basis of the email account information, extract online-purchased clothing-related information on the basis of the content of the extracted emails, and extract clothing-related core information from a product sale site corresponding to the online-purchased clothing-related information.

Further, the sever 200 can analyze emails received in the mail server on the basis of the email account information, in detail, can extract clothing-related emails by comparing clothing order confirmation mails, which are provided when clothing are purchased from a clothing sale online shopping mall or a clothing-related smart store, with a clothing order mail format made in advance into a database.

Further, the server 200 may also extract clothing-related emails on the basis of the titles of emails or the email addresses of email senders.

Further, the server 200 can extract online-purchased clothing-related information on the basis of the contents of the extracted clothing-related emails. In this case, the online-purchased clothing-related information may include at least one the sale route and the name of online-purchased clothing, and information about options of a user when purchasing the clothing in online.

Further, the server 200 performs OCR processing on an image included in the content of an extracted email and performs text parsing on the texts included in the content of the extracted email, thereby being able to extract online-purchased clothing-related information.

That is, the server 200 performs OCR processing on an image included in an extracted clothing-related email and performs text parsing on the texts included in the extracted clothing-related email, thereby being able to extract information about the sale route or sale website address, and the name of online-purchased clothing, and options selected by a user when purchasing clothing, for example, the size, color, price, purchase date, etc.

Further, the server 200 can extract clothing-related core information from a product sale site corresponding to online-purchased clothing-related information. The server 200 can search a product sale site on the basis of the sale route of clothing purchased in online, collect images and texts posted on the product sale site, and then extract and transmit clothing-related core information including images and texts related to the online-purchased clothing.

In detail, the server 200 can search for a sale site of corresponding clothing through the sale route or the sale website address of extracted online-purchased clothing, and can collect all images and texts related to the clothing posited on the searched sale site.

Further, the server 200 can perform an image refinement processing, which extracts an image having a high degree of matching to the image of the online-purchased clothing on the basis of an artificial intelligence model, on the images and texts related to the clothing on the collected sale site, and can sort images having high degree of matching to the online-purchased clothing into an image available as a product image, a wearing image, a photoshoot image, a size-related image, etc.

Further, the server 200 can perform a text refinement processing of searching for main keywords such as a material, a style, a feeling, a washing type, etc. by performing text parsing on the texts related to the clothing posited on the collected sale site.

Further, the server 200 transmits clothing-related core information including the image refinement-processed images and the text refinement-processed texts to the user terminal 100.

Further, when receiving the clothing-related core information, the user terminal 100 can register an image or a text selected by user's operation by a digital closet creator into a digital closet or can register an image or a text corrected by user's operation into a digital closet.

Meanwhile, a server 200 according to another embodiment of the present disclosure can receive information about clothing purchased in offline on the basis of identifier information, search for product data matched with the information about clothing purchased in offline from a product database, and transmit clothing-related core information including the information about clothing purchased in offline and matched product data to the user terminal.

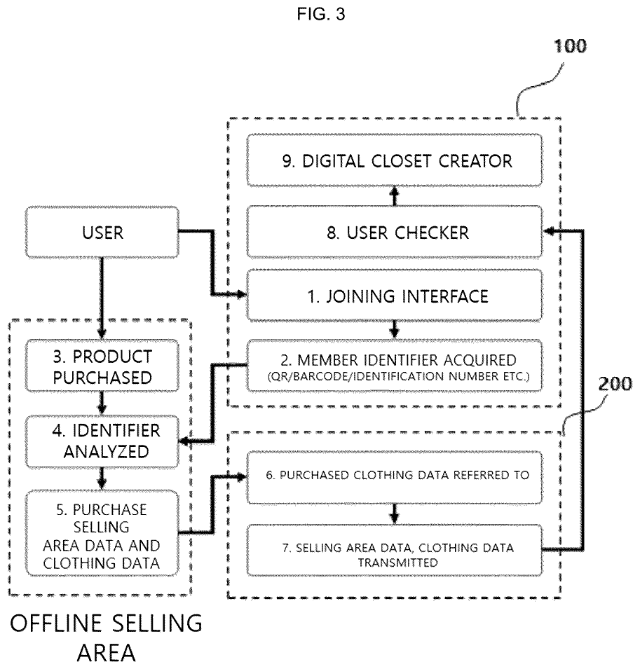

FIG. 3 is a diagram showing detailed data processing of the system for constructing a digital closet according to another embodiment of the present disclosure.

Referring to FIG. 3, a data processing process between the user terminal 100 and the server 200 of the system 10 for constructing a digital closet is shown. In detail, the digital closet service platform that is driven in the user terminal 100 is implemented as an application, a user has to perform joining in order to use this digital closet service platform, and an a user interface for supporting such joining can be displayed.

Further, the digital closet service platform that is driven in the user terminal 100 can provide a user with an identifier for digital closet registration.

In this case, the identifier may include a QR code, a barcode, an identification number, etc., and may be used when a user purchases clothing in offline.

For example, an identifier that is provided when a user purchase clothing in offline can be recognized through a sale time management device or a recognition device installed in a selling area.

The recognized identifier can be transmitted to the server 200 and simultaneously information about clothing purchased in offline can be transmitted.

In this case, the information about clothing purchased in offline may include at least one of the information of the selling area at which the clothing was purchased in offline, specification information about the clothing purchased in offline, and payment information.

Further, the server 200 can refer to clothing data through product databases of an online sale shopping mall, a smart store, etc. on the basis of the received offline-purchased clothing-related information.

That is, the server 200 can search for product data matched to the offline-purchased clothing-related information in the product databases of an online sale shopping mall, a smart store, etc.

In this case, the product data matched to the offline-purchased clothing-related information may include at least one of the image, name, and size of the clothing purchased in offline.

Further, the server 200 can transmit the offline-purchased clothing-related information including the information about the selling area at which the clothing was purchased in offline, specification information about the clothing purchased in offline, and payment information, and clothing-related core information including matched product data including at least one of the image, the name, and the size of the offline-purchased clothing.

Further, when receiving the clothing-related core information, the user terminal 100 can register an image or a text selected by user's operation by a digital closet creator into a digital closet or can register an image or a text corrected by user's operation into a digital closet.

As described above, when a user purchases clothing in online, the server 200 can find out a sale route from email information related to the purchased clothing, extract clothing-related core information from information such as images or texts in a corresponding clothing sale site, and transmit the clothing-related core information to the user terminal 100. When a user purchases clothing in offline, the server 200 can extract product data matched to the name, specification, selling area, price, etc. of the purchased clothing from identifier information related to the purchased clothing, and transmit the product data to the user terminal 100.

Accordingly, the user terminal 100 can easily construct a digital closet by registering the core information about clothing purchased in online or offline into the digital closet.

Meanwhile, the user terminal 100 analyzes similarity between images or text registered in the digital closet and pre-stored clothing data, and combines clothing of which the similarity satisfies a preset reference or more, thereby being able to create a coordinated combination.

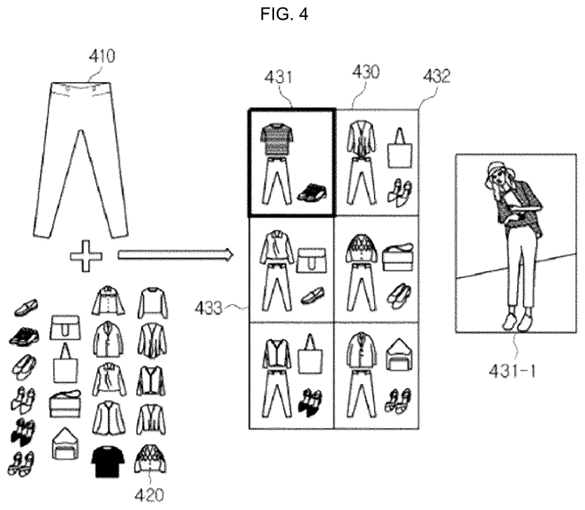

FIG. 4 is a diagram illustrating a method of creating a coordinated combination according to an embodiment of the present disclosure.

Referring to FIG. 4, the user terminal 100 can analyze similarity between a trousers image 410 registered in a digital closet and pre-stored clothing data 420, and create a plurality of clothing combinations 430 satisfying similarity over a predetermined level.

For example, a preset similarity reference may be 70 and a first coordinated combination 431 that is a combination of an upper garment and shoes of which similarity with a trousers image 410 registered in a digital closet is 80 and 90, respectively, may be created, and a second coordinated combination 432 that is a combination of an upper garment, a bag, and shoes of which similarity with a trousers image 410 registered in a digital closet is 75, 80, and 85, respectively, may be created. Similarly, various items 433 of items having similarity exceeding 70 that is a preset similarity reference may be formed.

Further, a photoshoot image or a wearing image 431-1 corresponding to each of the created coordinated combinations 431, 432, and 433 may be created.

Further, an entire matching index may be displayed for each of the created coordinated combinations 431, 432, and 433. For example, the matching index of the first coordinated combination 431 may be displayed as 80, the matching index of the second coordinated combination 432 may be displayed as 85, and the matching index of the third coordinated combination 433 may be displayed as 90, and the user terminal 100 can recommend coordinated combinations to a user in order of high matching index. The matching index may be calculated in consideration of the similarity between clothing items, weight of each necessary item, weight of each item for each season, etc.

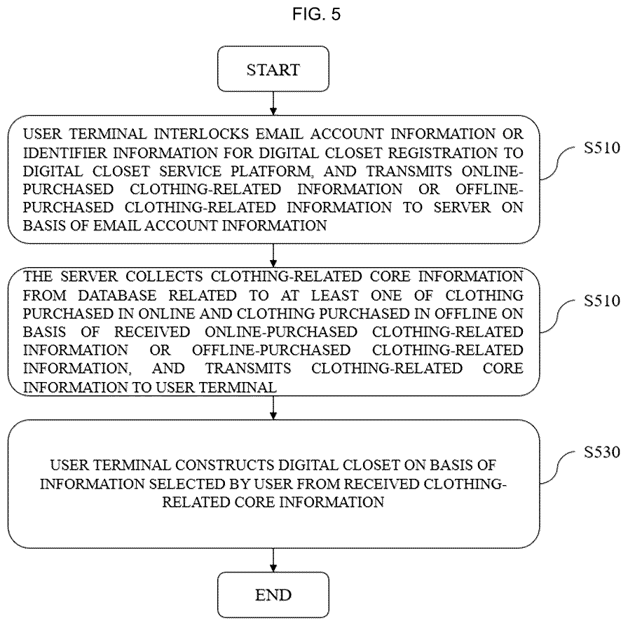

FIG. 5 is a flowchart illustrating a method of constructing a digital closet according to an embodiment of the present disclosure.

Referring to FIG. 5, a method of constructing a digital closet of a system for constructing a digital closet including a user terminal and a server according to an embodiment of the present disclosure includes: a step in which the user terminal 100 interlocks email account information or identifier information for digital closet registration to a digital closet service platform, and transmits online-purchased clothing-related information or offline-purchased clothing-related information to the server 200 on the basis of the email account information (S510); a step in which the server 200 collects clothing-related core information from a database related to at least one of the clothing purchased in online and the clothing purchased in offline on the basis of the received online-purchased clothing-related information or offline-purchased clothing-related information, and transmits the clothing-related core information to the user terminal 100 (S520); and a step in which the user terminal 100 constructs a digital closet on the basis of information selected by a user from the received clothing-related core information (S530).

Meanwhile, a non-transitory computer readable medium in which a program that sequentially performs the method of constructing a digital closet according to the present disclosure is stored may be provided.

The non-transitory computer readable media is not a media that stores data for a short time such as a cache, and a memory, but a media that can semipermanently store data and can be read out by a device. In detail, the various applications or programs described above may be stored and provided in a non-transitory computer readable medium such as a CD, a DVD, a hard disk, a blueray disc, a USB, a memory card, and a ROM.

Further, a bus is not shown in the block diagram described about the server that collects clothing-related core information from a database related to purchased clothing on the basis of email account information or identifier information, transmits the clothing-related core information to the user terminal extracts a clothing-related email from emails received in a mail server on the basis of the email account information, extracts online-purchased clothing-related information on the basis of the contents of the extracted email, and extracts clothing-related core information from a product sale site corresponding to the online-purchased clothing-related information, but communication between the components of the server may be performed through a bus. Further, each device may further include a processor such as a CPU, a microprocessor, etc. that performs the various steps described above.

Further, although exemplary embodiments of the present disclosure were illustrated and described above, the present disclosure is not limited to the specific exemplary embodiments and may be modified in various ways by those skilled in the art without departing from the scope of the present disclosure described in claims, and the modified examples should not be construed independently from the spirit of the scope of the present disclosure.

What is claimed is:

1. A system for constructing a digital closet, comprising:
a user terminal that interlocks email account information or identifier information for digital closet registration to a digital closet service platform, receives core information related to clothing purchased in online or offline, and creates a digital close on the basis of information selected by a user from the received clothing-related core information; and
a server that collects the clothing-related core information from a database related to the purchased clothing on the basis of the email account information or the identifier information, and transmits the clothing-related core information to the user terminal.

2. The system of claim 1, wherein the server extracts an clothing-related email from emails received in a mail server on the basis of the email account information, extracts information about the clothing purchased in online on the basis of the content of the extracted email, and extracts the clothing-related core information from a product sale site corresponding to the information about the clothing purchased in online.

3. The system of claim 2, wherein the online-purchased clothing-related information includes at least one a sale route and a name of the clothing purchased in online, and information about options of the user when purchasing the clothing in online, and
the server performs OCR processing on an image included in the content of the extracted email, and performs text parsing on a text included in the content of the extracted email, thereby extracting the online-purchased clothing-related information.

4. The system of claim 3, wherein the server searches for the product sale site on the basis of the sale route of the online-purchased clothing, collects images and texts posted on the product sale site, and extracts and transmits the clothing-related core information including an image and a text related to the online-purchased clothing to the user terminal.

5. The system of claim 4, wherein the server receives information about clothing purchase in offline on the basis of the identifier information, searches for product data matched to the offline-purchased clothing-related information from a product database, and transmits the offline-purchased clothing-related information and the clothing-related core information including the matched product data to the user terminal.

6. The system of claim 5, wherein the offline-purchased clothing-related information includes at least one of the information of a selling area at which the clothing was purchased in offline, specification information about the clothing purchased in offline, and payment information.

7. The system of claim 6, wherein the matched product data includes at least one of an image, a name, and a size of the offline-purchased clothing.

8. The system of claim 7, wherein when receiving the clothing-related core information, the user terminal registers an image or a text selected by user's operation in a digital closet or registers an image or a text corrected by user's operation in a digital closet.

9. The system of claim 8, wherein the user terminal analyzes similarity between the image or the text registered in the digital closet and pre-stored clothing data, combines clothing of which the similarity satisfies a preset reference or more, thereby creating a coordinated combination.

10. A method of constructing a digital closet of a system for constructing a digital closet including a user terminal and a server, the method comprising:
a step in which the user terminal interlocks email account information or identifier information for digital closet registration to a digital closet service platform, and transmits online-purchased clothing-related information or offline-purchased clothing-related information to the server on the basis of the email account information;
a step in which the server collects clothing-related core information from a database related to at least one of the clothing purchased in online and the clothing purchased in offline on the basis of the received online-purchased clothing-related information or offline-purchased clothing-related information, and transmits the clothing-related core information to the user terminal; and
a step in which the user terminal constructs a digital closet on the basis of information selected by a user from the received clothing-related core information.
